(19) United States
(12) Patent Application Publication
(10) Pub. No.: US 2024/0286161 A1
(43) Pub. Date: Aug. 29, 2024

(54) TOUCHLESS COSMETIC LIQUID SAMPLING SYSTEM

(71) Applicant: INNOLIS, Saint-Marcel-les-Valence (FR)

(72) Inventors: Laurent FOUCHER, Lyon (FR); Wim MEULENKAMP, Lyon (FR)

(21) Appl. No.: 18/572,090

(22) PCT Filed: Jun. 28, 2022
(86) PCT No.: PCT/EP2022/067652

§ 371 Date: Dec. 19, 2023

Related U.S. Application Data
(60) Provisional application No. 63/217,108, filed on Jun. 30, 2021.

(51) Int. Cl. B05B 12/12; A45D 40/00; B05B 9/04; B05B 12/00

(52) U.S. Cl. CPC B05B 12/122; A45D 40/0087; B05B 9/0413; B05B 12/004

(57) ABSTRACT

Various embodiments disclosed relate to a system for touchless dispensing of cosmetic samples. The present disclosure includes systems and methods for metered dispensing of cosmetic samples through a pump system with a universal bottle adapter and a proximity sensor induced droplet production.

### BACKGROUND

Beauty counters and stores often carry a large variety of cosmetics and fragrances, many of which are fluid or liquid. Typically, the customers prefer to sample cosmetics or fragrances prior to purchase. However, in the wake of the COVID-19 pandemic, retailers and customers prefer to avoid touching tubes, containers, or samples, that may have also been handled by other persons. Additionally, spraying of fragrances for sampling is discouraged in a pandemic world. Determining how to sample these various cosmetics without cross-contamination and touching can be challenging.

Moreover, each type of fragrance and cosmetic bottle or container can be a different size and shape. For this reason, many sampling systems or methods require new or different containers or swabs to properly sample the cosmetic or fragrance. Additionally, samplings can be uneven in volume or amount when provided to the customer. Current methods of sampling can include cartridges configured to release a scent and refillable containers.

### SUMMARY OF THE DISCLOSURE

The present disclosure provides a universal sampling system for cosmetic liquids. The system can include a universal cosmetic packaging connector, a feedback loop system for metering out appropriate samples at a desired timing, and a cosmetic identification system. In some cases, the disclosed system and methods can include an artificial intelligence vision identification system for identification of cosmetic bottles. In some cases, the disclosed system and methods can include delivering a tailored droplet at a desired sample size. In this system, a consumer product which is typically sampled through spraying, can be delivered as a measured droplet for sampling.

Consumers like to test cosmetics prior to purchase. However, current sampling and testing techniques used in-store often require touching of swabs, bottles, or other methods where the consumer or the retailer are touching a variety of surfaces. Moreover, complex sampling systems targeted to reduce touch are not universal. A different sampling system must be used by the retailer for each type of cosmetic, bottle, and pump. Some of these approaches use cartridges or refillable containers that plug into a sampling system.

There is a need for smart sampling systems that can dynamically adjust to product connected, display alerts when maintenance is required or product is empty, and allow storing of the information to further optimize the placement of devices in a store. This type of system can aid in delivering metered, droplets of cosmetic products for sampling.

Discussed herein is a universal sampling system that can connect with a variety of cosmetic bottle types for easy, touchless sampling of cosmetic liquids, such as, on the shelves, at a beauty counter or other cosmetic retailer. The systems discussed herein can serve as a combined retail display and dispenser. The system can use a proximity sensor to measure and pump a specified amount of cosmetic liquid for delivering as a sample at a time that a user is interested in a sample.

The universal sampling system can be used to connect to existing, commercially available products. This can prevent a change in shop product stock space for sampling purposes, and prevent duplication of the supply chain for manufacturers. Moreover, the system can be very precise with sample delivery, producing an accurately measured droplet of sample cosmetic product to a consumer. This can help reduce waste in sampling of cosmetic products.

In an example, a dispensing system can include a bottle connector for receiving a bottle containing a cosmetic liquid, wherein the bottle connector is a universal connector, the bottle connector comprising: a tapered connector sized to receive a valve of the bottle; and a height adjustment mechanism to accommodate different sizes of bottles; a pre-loaded spring allowing for adjustment of the valve height; a dispensing arm fluidly connected to the bottle connector, the dispensing arm for dispensing a measured amount of the cosmetic liquid; and a pump fluidly connected to the cosmetics bottle.

In an example, a dispensing system can include: a bottle connector configured for attaching the system to a cosmetic packaging for containing a cosmetic liquid; a dispensing arm fluidly connected to the bottle connector, the dispensing arm comprising an opening for dispensing a measured amount of the cosmetic liquid; a pump actuatable for pumping the cosmetic liquid from the cosmetics bottle through the bottle connector to the dispensing arm and through the opening; a proximity sensor on a distal portion of the dispensing arm configured to sense the proximity of a surface for dispensing the cosmetic liquid; and an opening sensor adjacent the opening for dispensing the cosmetic liquid, the opening sensor configured to detect when the measured amount of the cosmetic liquid has been dispensed.

In an example, a system can include a processor and a memory, the memory including instructions which, when executed, cause the processor to receive a signal from a proximity sensor, the signal indicating that an external surface is near a dispensing arm; pump a predetermined amount of cosmetic fluid through a universal adapter to the dispensing arm; and deliver the cosmetic fluid out an opening in the dispensing arm to the external surface.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1C illustrate a cosmetic sampling system in an example.

FIG. 2 illustrates a universal connector for use with the cosmetic sampling system of FIGS. 1A-1C in an example.

FIG. 3 illustrates a drop sensor system for use with the cosmetic sampling system of FIGS. 1A-1C in an example.

FIG. 4 illustrates a block diagram of an example computing machine upon which any one or more of the techniques or methodologies discussed herein may be implemented.

### DETAILED DESCRIPTION

The present disclosure describes, among other things, systems and methods for measured volumetric dispensing of cosmetic fluids, such as for sampling in a retail setting. The system can allow for delivery of measured droplets of cosmetic fluid to the consumer. The system can include a universal cosmetic packaging connector and bottle adapter and a feedback sensor system for efficient and effective dispensing of sample sizes. Discussed herein, a system for sampling cosmetic liquids can be a universal connection apparatus used for affixing a cosmetic fluid container to an electrical device for the purpose of extracting a fluid.

An example system can include a cosmetic connector for receiving a bottle or package containing a cosmetic liquid. The connector can be a universal connector. The connector can include a tapered connector sized to receive a piston valve of a pump mechanism mounted on the cosmetic package. The tapered connector can be connected to a pre-loaded spring that can exert a constant downward pressure on the piston valve to create a leak free, airtight seal. The system can automatically adjust its height to accommodate different package dimensions, such as by movement on a sliding axes. Thus, in one cinematic movement, the tapered connector can push down on the piston valve with a force of about 0.5 kg to about 4.0 kg with different heights of piston valve displacement taken into account. This movement can allow for opening of the piston valve system in the cosmetic packaging. The system can have a pump that extracts liquid out of the cosmetic package through the piston valve, and subsequently let air into the package. The dispensing arm can be fluidly connected to the cosmetic connector, and allow for dispensing of a measured amount of the cosmetic liquid.

In an example, the system can include a universal cosmetic packaging connector, a feedback loop system for metering out appropriate samples at a desired timing, and a cosmetic identification system. In some cases, the disclosed system and methods can include an artificial intelligence vision identification system for identification of cosmetic bottles. In some cases, the disclosed system and methods can include delivering a tailored droplet at a desired sample size.

As used herein, “cosmetic fluid” can include both gas and liquid fluids. As used herein, “cosmetic liquid” can include a fluid that conforms to the shape of its container but retains a constant volume independent of pressure. Cosmetic fluids and liquids can include, for example, creams, gels, foams, fragrances, aqueous solutions, and other liquids.

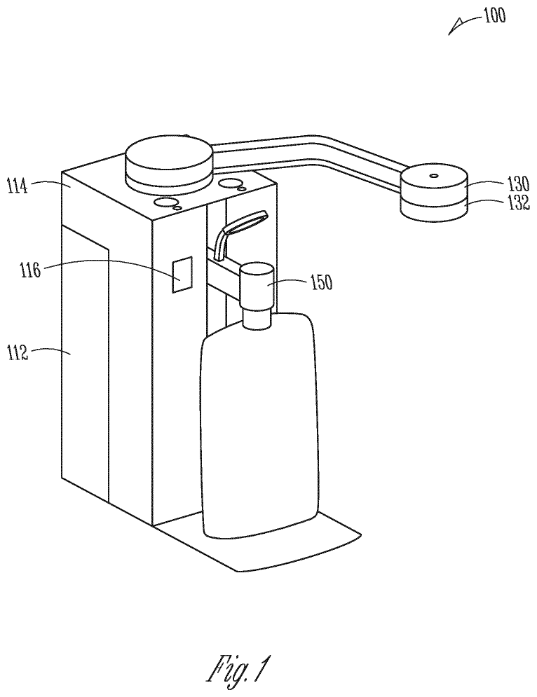

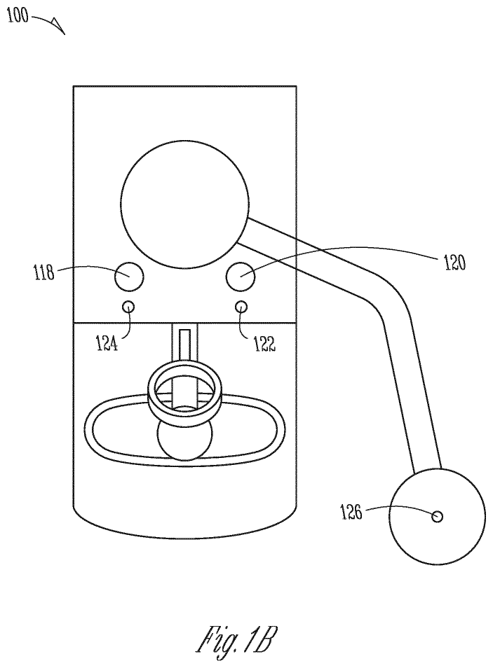

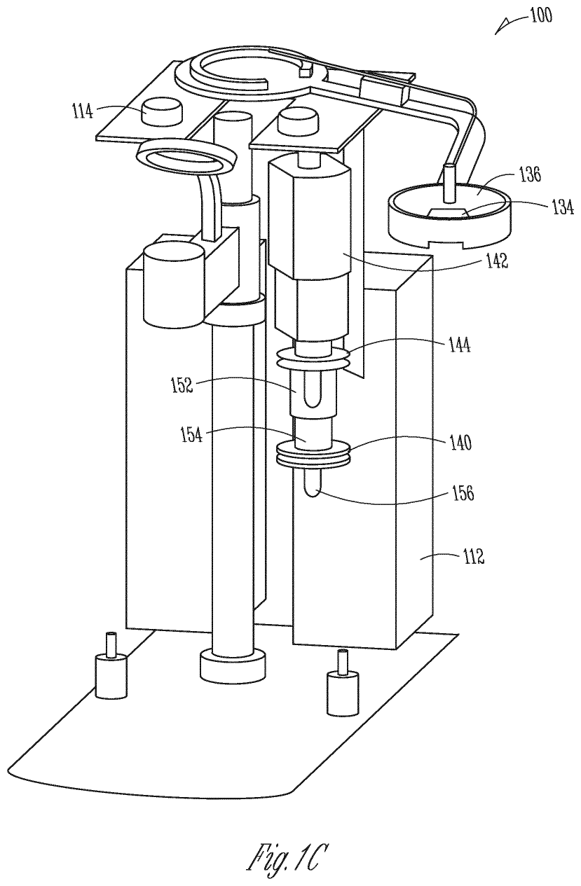

FIGS. 1A-1C illustrate a touchless cosmetic liquid sampling system 100. FIG. 1A illustrates a perspective view of the system 100. FIG. 1B depicts a top down view of the system 100. FIG. 1C depicts an internal view of the system 100. FIGS. 1A-1C will be discussed together.

The system 100 can be a non-contact (touchless) variable fluid dispensing system for cosmetic sampling. The system 100 can include housing 110, external battery 112, network interface 114, camera 116, buttons 118, 120, LED indicators 122, 124, 126, connecting tube 128, arm 130 with drop dispensing exit zone 132, sensors 134, 136, micropump 140, motor unit 142, motor axis sensor 144, and universal connector 150 with an actuating lever 152 and a pre-loaded spring 154.

In the system 100, the cosmetic fluid container can be isolated from the external environment through a connecting valve un the universal bottle connector 150. The cosmetic fluid container can be disposed outside the housing 110. The micropump 140 can be configured to draw cosmetic fluid out of the cosmetic fluid container, driven by the motor unit 142. The connecting tube 128 can fluidly connect the micropump 140 to the arm 130, and the micropump 140 can pump cosmetic fluid up to the arm 130 and out the exit zone 132. The universal bottler connector 150 can include the lever 152 and spring 154, which can keep the cosmetic fluid container valve in an open position, letting air into the container. The sensor 134 can be a proximity sensor for determining when a hand or other surface desiring a sample is within a predetermined proximity, and communicate to the process, which can determine when to provide a sample. The sensor 136, on the arm 130, can be used to monitor the cosmetic fluid output. The buttons 118, 120 can be used for configuring the system 100. The indicators 122, 124, 126, can be used to monitor the system 100. The external battery 112 can be used to power the system 100.

The housing 110 can be a container at least partially enclosing the system 100. In some cases, the housing 110 can be made of a polymer, a plastic, a metallic, or a composite material. In some cases, the housing 110 can include one or more windows or clear portions such that a bottle of cosmetics can be seen through the window. The housing 110 can enclose or partially enclose many of the components of the system 100. In some cases, the housing can be placed behind the bottle in a retail display, such that the bottle is visible to consumers. In some cases, the housing can be placed in front of the bottle; in this case, a sticker or other label can be used to show to the consumer which sample is in the housing.

The external battery 112 can include a portable power source, such as a battery, to power the system 100. In some examples, the external battery 112 can include more than one battery. For example, shown in FIGS. 1A-1C, the external battery 112 can include two power ports to allow for two batteries to be in place simultaneously. Thus, if one of the batteries fails, the system 100 can switch to the other battery. In some cases, the batteries can be disposable. In some cases, the batteries can be multi-use, rechargeable batteries. In some cases, the system can be connected to a power socket, such as through a USB power socket. The external battery 112 can be electrically connected to the system 100 to allow for electrical functioning of the pump 140 and other components of the system 100.

The network interface 114 can be, for example, a printed circuit board or other component to allow for network access to the system 100. In some cases, the network access can be to a wireless network. The network interface 114 can allow for collection of data from the system 100, and for communication with one or more external computers, such as for data analysis or machine learning methods for more efficient use of the system 100. Examples of such techniques are discussed in more detail below.

In some cases, the system 100 can further include a processing unit. The processing unit can contain a memory for storing at least temporarily one or more of the information from each time the sensor detects an external surface, a fluid connecting bottle being disconnected or connected to the system 100, and time-stamps associated with sensor activation, bottle connections/disconnections to the system 100 or other events. In some cases, the information of the processing unit can be transmitted through the network interface 114 to an external computer system or server. In some cases, the processing unit can include a communication interface for transmitting information from the detection member to an external server.

The camera 116 can be situated at least partially within the housing 110. The camera can include a lens situated for capturing an image of the bottle installed in the system 100. For example, the camera 116 can be situated facing the bottle connection, such that it can image capture a portion of the bottle, such as the bottle label. The camera 116 can be in communication with the network interface 114 so as to send captured image data. The camera 116 and associated image analysis can be used, in some cases, for purposes of identification of the cosmetic type. In some cases, the camera 116 and associated image analysis can be used to identify the type of cosmetic in the bottle. In some cases, other types of identification methods can be used. Non-limiting examples of such identification methods may include reading a quick response (QR) code, optical character recognition (OCR) of text printed on a label, and other methods.

The buttons 118, 120, can be situated, for example, on a top surface of the housing 110. The buttons 118, 120, can be sized and shaped for allowing a user to trigger or press the button and activate one or more functions of the system 100. Additionally, or alternatively, buttons can be elsewhere on the system for activation of various functions of the system 100. In system 100, button 118 can be used for turning the system 100 off and on, while button 120 can be used for calibrating, priming, and, purging the system 100. In some cases, the buttons can be supplemented or replaced by a different type of user interface, such as a touch screen, or a blue tooth connection to a smart phone or device.

Indicators 122, 124, 126, can include one or more small visual indicators, such as circular light emitting diodes (LED) lights. The indicators 122, 124, 126, can in some cases be of different colors to convey different indications or alerts to the user. For example, an indicator can show a red light if the bottle is low or empty. In some cases, the indicator light can be white to show the system is functioning as intended. Some indicators can use blinking patterns to convey meaning. In some cases, the indicator lights can be used to convey battery life, pump use, liquid level, or other information about the system 100. In some cases, one or more of the indicators can be programmed to indicate a malfunction of the system 100. In some cases, other visual indicators can be used.

The arm 130 can be connected to and extend from the housing 110 and the pump 140. The arm 130 can, for example, extend outward at an angle from the system 100 to allow for easy reach and access by a user desiring a sample of the cosmetic product in the bottle. The arm 130 can include one or more openings, such as the drop dispensing exit zone 132, for delivery of the sample cosmetic liquid to the user. The arm 130 can be configured to deliver the sample in a droplet or drop form. The arm 130 can include one or more sensors for detecting movement of liquid therethrough. The arm 130 can be fluidly connected to the micropump 140 by tubing 128. In some cases, the opening can be integrated with the tubing 128. In some cases, the arm 130 and associated tubing 128 can be self-cleaning. The arm 130 can be at an angle of about 180 degrees or less, or at an angle of about 120 degrees or less. In some cases, the arm 130 can be able to pivot about 200 degrees.

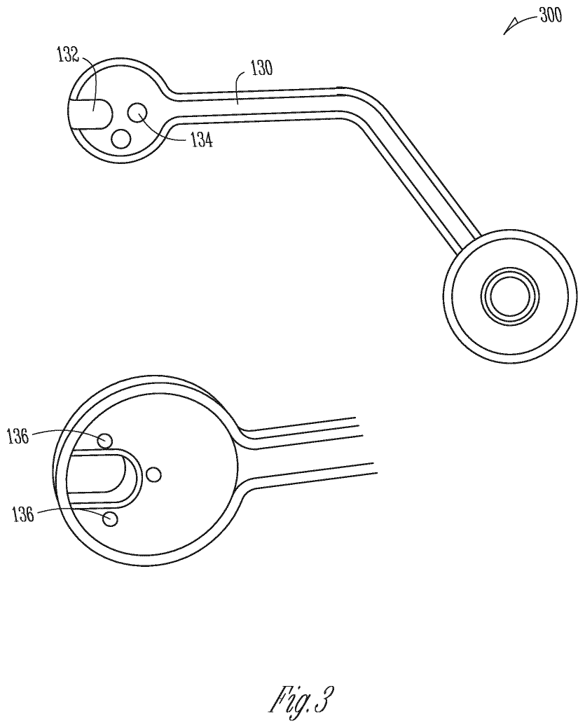

The drop dispensing exit zone 132 can include a hole or other opening fluidly connected through the pump 140 to the bottle. The sensors 134, 136, can be, for example, infrared (IR) sensors, or other types of spatial sensors that determine when a drop sample of the cosmetic liquid is delivered to the user out of the drop dispensing exit zone 132. The sensor 134, for example, can be a proximity sensor that triggers delivery of a sample when an external surface is in a proximity zone below the arm 130. The external surface can be, for example, a user's hand. In some cases, the external surface can be a swab, sponge, card, strip, or other item for transfer of the sample cosmetic liquid. This can help avoid unnecessary distribution of the cosmetic liquid. An example sensor system for the arm 130 is discussed in more detail below with reference to FIG. 3.

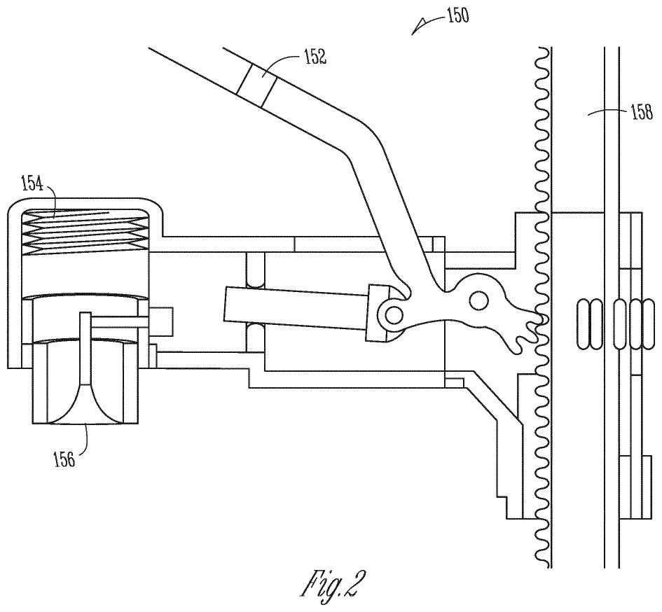

The micropump 140 can be a pump situated within the housing 110 and fluidly connected to the bottle. The micropump 140 can be connected to the bottle with the universal connector 150. The micropump 140 can be actuatable for pumping a predetermined amount of fluid from the bottle out to the arm 130 and as a portioned sample out the exit zone 132 to the user. In some cases, the pump can be volumetric. When in use, the micropump 140 can be connected to the cosmetic packaging through the universal cosmetic packaging connector to the valve (e.g., a piston valve) in the cosmetic packaging. Shown in FIG. 2, the micropump 140 can be connected, for example, through a tapered connector piece. When in use, the universal connector 150 can, through a pre-loaded spring, press down on the piston valve of the cosmetic package connected to the system 100. This can be actuated with a pressure of about 0.5 to about 4.0 kg, for example. This can open the piston valve in the cosmetics packaging to allow extraction of cosmetic fluid up through the micropump 140 and the system 100. Simultaneously, air can be let into the cosmetics package to equalize the pressure in the cosmetic packaging.

The cosmetic fluid can be pumped up to the arm 130 for delivery. The micropump 140 can be configured to measure and deliver a small amount of the cosmetic liquid, such as about 8 to 32 μL or about 8 to 16 μL. In some cases, the micropump 140 can deliver samples in increments of about 4 to 16 μL. The micropump 140 can be configured to dispense fluid at a rate of about 16 to 100 μL per second.

The motor unit 142 can be coupled to the micropump 140 to initiate pumping of the cosmetic fluid for production of a sample at the arm 130. The motor axis sensor 144 can be in communication with the motor unit 142 to aid in alignment of the motor unit 142 and the micropump 140. In some cases, the lever 152 in actuated combination with preloaded spring 154 can apply a pressure of about 0.5 to about 4 kg.

The universal connector 150 can be shaped like a bottle cap, for connection to a cosmetic fluid container. The connected cosmetic fluid container can have a connection face with a spring-loaded valve. The system can have a universal adapter that allows for opening of the valve on the fluid container. The universal adapter can have a conical, stepped, or tapered hollow shape for contacting the spring-loaded valve. In some cases, a dip tube can be used in conjunction with the universal connector 150 to fluidly couple the bottle of cosmetic fluid to the system 100. The universal bottle connection 150 is shown and discussed in more detail with reference to FIG. 2.

FIG. 2 illustrates a universal bottle connector 150 for use with the cosmetic sampling system 100. The bottle connector 150 can include the actuating lever 152, the pre-loaded spring 154 with a tapered shape 156, and a height adjustment mechanism 158. In some cases, a different actuating mechanism can be used in lieu of the lever 152.

The universal cosmetic packaging connector 150 can be an apparatus for affixing a cosmetic fluid container to the electrical dispensing system, such as system 100 above. The system 100 can extract the cosmetic fluid from the bottle connected through the universal bottle connector 150. The bottle connector 150 end can look similar to a regular bottle cap for retail appeal.

The universal connector 150 can be used with a multitude of brands each having different bottle designs, materials, dimensions, and pump types, pump diameters that have spring-loaded valves. This can allow for a variety of different tester bottles, with various spray pump types. This can allow for easy switching of bottles without the need for additional bottles, connectors, and reservoirs of cosmetics. The universal bottle connector 150 can additionally allow for a leak-free connection, and an airtight system to apply the appropriate downward pressure to open existing spray pump types.

The cosmetic packaging can be a fluid container that includes a spring-loaded valve, such as a bottle. The universal connector 150 can be configured to attach to and open the valve attached to the fluid container. The pre-loaded spring 154 can be configured to push, with a predetermined force, the tapered shape 156 down to open the valve of the fluid container and secure the fluid container to the connector 150 regardless of the shape of the spring-loaded valve. The tapered shape 156 can be, for example, a conical, stepped conical, or tapered hollow shape for contacting the spring-loaded valve. The lever 152 in combination with the pre-loaded spring 154 can be actuated with a predetermined force of about 0.5 to 4 kg to open the spring-loaded valve of the fluid container and lock the container to the connector 150.

In some cases, the connection of the fluid container to the universal connector 150 can be indicated, such as with one of the LED indicators, to show the bottle is well aligned and leak-free and airtight. In some cases, the connection can be secured automatically, in some cases the connection can be secured manually, such as with a lever. In some cases, the alignment of the motor 142 can be checked and altered by the motor axis sensor 144. The motor axis sensor 144 can, for example, determine whether the bottle connector 150 is properly aligned with the pump 140, and help improved the accuracy of dosing.

The universal connector 150 can additionally be height-adjustable with the mechanism 158. For example, in FIG. 2, the mechanism 158 can include sliding axis or other type of mechanism which can be changed to adjust the height to accommodate different bottle dimensions. The actuating lever 152 can be adjusted accordingly, such as with one hand. When in use, the system 100 can push down on the tapered shape 156 with a force of about 0.5 kg to about 4.0 kg. This movement can allow opening the valve system of any spray pump so as to allow the internal pump to extract the liquid out of the bottle and, subsequently, let the air in.

FIG. 3 illustrates a drop sensor system 300 for use with the cosmetic sampling system 100. The sensor system 300 can include the arm 130, the opening 132, the proximity sensor 134, the opening sensor 136. In the system 300, the arm 130 can include a proximity sensor 134 configured to detect a nearby object for which a sample is desired. The opening sensor 136 can be used in conjunction with a processing unit and network connection to monitor the amount of cosmetic liquid being dispensed.

The system 100 can be used to deliver a droplet of a multitude of cosmetic products, such as liquids, make-up, fragrances, and skin care products. The delivery of samples of these cosmetic products can be unscheduled. The use of the proximity sensor 134 can allow for dispersion of samples when a customer or retailer is ready. However, this means the system may need to compensate for deviations over time. Surface tension, such as at the opening 132 at the end of the arm 130, can change over time, with dust, and other environmental factors. This can lead to slower dispersion of droplets, or potentially clogs. Monitoring surface tension and the time between drop exits can address these potential issues.

Thus, sensors 136 can be drop exit sensors, for monitoring the measurement of cosmetic droplet dispensed at the opening 132. This can aid in efficient delivery to a consumer without unwanted waiting. This can additionally address evaporation or retraction of cosmetic product in the tubing 128.

The drop exit sensors 136 can be used to sense when a droplet is dispensed from the system 100. This can allow for detection of the timing of dispensed droplets, and the amount of liquid dispensed. The system 100 can, with the processing unit and the network interface 114, determine a change in time from the last drop exited to the moment where a new drop is demanded by the consumer.

In some cases, the droplet at the opening 132 of the arm 130 can be measured from IR refraction and deviation. This can allow analysis of what liquid is available at the tip of the arm 130 for drop exit, or periodically drive the pump until one or more droplets are delivered. In some cases, the system 100 can automatically advance the micropump 140 to move the liquid in the tubing 128 to compensate for evaporated or retracted liquid. The system 100 can calculate retracted and evaporated liquid through a variety of parameters, such as time used, liquid type, and external temperature. Such information can optionally be sent to and stored on the cloud or an external server, such as by the network interface 114 (see FIG. 1A).

The sensor system 300 can reduce the time between the proximity sensor 134 activation and drop dispensing onto the external surface (e.g., a consumer hand). The exit sensors 136 can determine when a drop has been expulsed through the opening 132 on the arm 130. The system 100 can calculate continuously the time since the last drop has been expulsed. A pre-determined time limit between drops can be set. For example, the time limit can be about thirty minutes to about six hours. If the time limit is reached without a drop, the system can actuate the micropump 140 to drive fluid through the system 100. The micropump 140 can continue to pump until another drop is detected by the sensor 136. The movement of the micropump 140 can be based on a number of factors, such as liquid type, external temperature, and time since last drop.

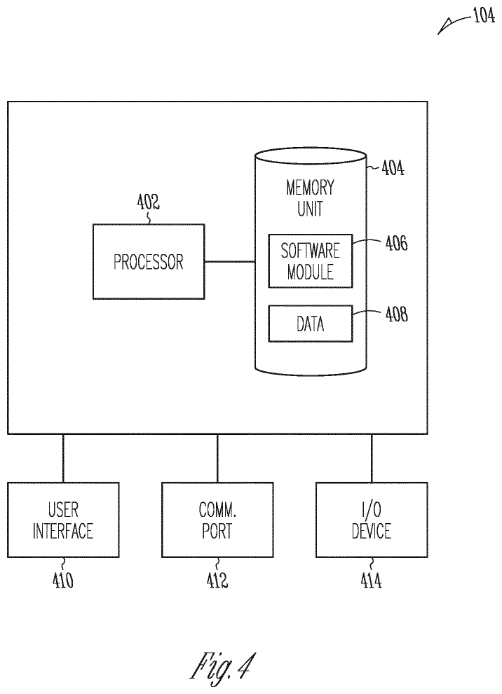

FIG. 4 illustrates a block diagram of an example computing system machine 400 upon which any one or more of the techniques (e.g., methodologies) discussed herein may perform. FIG. 4 shows an example schematic of the computing device 400 consistent with embodiments disclosed herein. The computing device 400 may include a computing environment 401, which may include a processor 402 and a memory unit 404. The memory unit 404 may include a software module 406, and other data 408.

In some embodiments, memory unit 404 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Memory unit 208 may also include non-volatile memory, which may include, but is not limited to, flash memory, phase change memory (PCM), read-only memory (ROM), electrically erasable programmable read-only memory (EEPROM), or any other type of non-volatile memory device.

Memory unit 404 stores information and instructions to be executed by processor 402. In one embodiment, memory unit 404 may also store temporary variables or other intermediate information while processor 402 is executing instructions. In the illustrated embodiment, processor 402 is in electrical communication with memory unit 404 In various embodiments, a chipset or other bus structure may enable processor 402 to connect to other elements in system to communicate with a network.

The computing device 400 may also include a user interface 410. The user interface 410 may include any number of devices that allow a user to interface with the computing device 400. Non-limiting examples of the user interface 410 may include a keypad, a microphone, a speaker, a display (touchscreen or otherwise), etc.

The computing device 400 may also include a communications port 412. The communications port 412 may allow the computing device 400 to communicate with information systems such as those operated and maintained by a shipping company, etc. Non-limiting examples of the communications port 412 may include, Ethernet cards (wireless or wired), Bluetooth® transmitters and receivers, near-field communications modules, cellular modules, etc. The computing device 400 may also include an input/output (I/O) device 414. The I/O device 414 may allow the computing device 400 to receive and output information. Non-limiting examples of the I/O device 414 may include a camera (still or video, such as the camera), a printer, a scanner, a scale, or others.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

### Various Notes & Examples

In Example 1, a dispensing system can include a cosmetic packaging connector for receiving a bottle containing a cosmetic liquid, wherein the connector is a universal connector, the bottle connector comprising: a tapered connector sized to receive a valve of the bottle; and a height adjustment mechanism to accommodate different sizes of bottles; a dispensing arm fluidly connected to the bottle connector, the dispensing arm for dispensing a measured amount of the cosmetic liquid; and a pump fluidly connected to the cosmetics bottle.

Example 2 can include Example 1, wherein the valve of the bottle comprises a spring-loaded valve.

Example 3 can include any of Examples 1-2, therein the tapered connector comprises a conical, stepped conical, or tapered hollow shape.

Example 4 can include any of Examples 1-3, the bottle connector comprising an actuator configured to move the tapered connector against the valve.

Example 5 can include any of Examples 1-4, wherein the actuator is an automated actuator.

Example 6 can include any of Examples 1-5, wherein the actuator is a lever.

Example 7 can include any of Examples 1-6, wherein the universal bottle connector is configured to provide an airtight connection to the bottle.

Example 8 can include any of Examples 1-7, further comprising a visual indicator for indicating when the bottle connector is secured to the bottle.

Example 9 can include any of Examples 1-8, wherein the universal bottle connector is configured to attach to a bottle external to the system.

Example 10 can include any of Examples 1-9, further comprising a housing at least partially enclosing the system.

Example 11 can include any of Examples 1-10, further comprising: a motor configured to run the pump; and a motor axis sensor configured to monitor position of the motor and pump relative each other.

Example 12 can include any of Examples 1-11, further comprising a dispensing tube connecting the pump to the bottle connector.

Example 13 can include any of Examples 1-13, further comprising a proximity sensor connected to the arm, the proximity sensor configured to detect an external surface near an opening in the arm.

Example 14 can include any of Examples 1-13, wherein the external surface is a hand.

Example 15 can include any of Examples 1-14, wherein the external surface is a sponge, pad, card, or strip.

Example 16 can include any of Examples 1-15, further comprising a power source connected to the pump and the arm, wherein the power source is portable.

Example 17 can include a dispensing system comprising: a bottle connector configured for attaching the system to a bottle for containing a cosmetic liquid; a dispensing arm fluidly connected to the bottle connector, the dispensing arm comprising an opening for dispensing a measured amount of the cosmetic liquid; a pump actuatable for pumping the cosmetic liquid from the cosmetics bottle through the bottle connector to the dispensing arm and through the opening; a proximity sensor on a distal portion of the dispensing arm configured to sense the proximity of a hand for dispensing the cosmetic liquid; and an opening sensor adjacent the opening for dispensing the cosmetic liquid, the opening sensor configured to detect when the measured amount of the cosmetic liquid has been dispensed.

Example 18 can include Example 17, further comprising a processing unit and a network connection in communication with the proximity sensor and the opening sensor.

Example 19 can include any of Examples 17-18, further comprising a camera situated within the system.

Example 20 can include a system comprising a processor and a memory, the memory including instructions which, when executed, cause the processor to: receive a signal from a proximity sensor, the signal indicating that an external surface is near a dispensing arm; pump a predetermined amount of cosmetic fluid through a universal adapter to the dispensing arm; and deliver the cosmetic fluid out an opening in the dispensing arm to the external surface.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A dispensing system (100) comprising:
a bottle connector (150) configured for attaching the system to a bottle for containing a cosmetic liquid;
a dispensing arm (130) fluidly connected to the bottle connector, the dispensing arm comprising an opening (132) for dispensing a measured amount of the cosmetic liquid;
a pump (140) actuatable for pumping the cosmetic liquid from the cosmetics bottle through the bottle connector to the dispensing arm and through the opening;
a spatial proximity sensor (134) on a distal portion of the dispensing arm configured to sense the proximity of a surface for dispensing the cosmetic liquid; and
a spatial opening sensor (136) adjacent the opening for dispensing the cosmetic liquid, the opening sensor configured to detect when the measured amount of the cosmetic liquid has been dispensed.

2. System according to claim 1, further comprising a processing unit and a network connection in communication with the proximity sensor (134) and the opening sensor (136).

3. System according to claim 1, further comprising a camera (116) situated within the system.

4. System according to claim 1, wherein the measured amount of the cosmetic liquid is about 16 μL to about 1,000 μL.

5. (canceled)

6. System according to claim 2, wherein the processing unit comprises a communication interface (114) configured for transmitting information from the system to an external data server.

7. System according to claim 2, wherein the processing unit comprises a memory for storing a record of times the proximity sensor detects the proximity of a surface for dispensing the cosmetic liquid

8. System according to claim 1, characterized in that it comprises a memory for storing a record of battery charge, fluid connections, operation of buttons, camera images, time stamps, and combinations thereof.

9. A cosmetic dispensing system (100) comprising:
a connector (150) for receiving a packaging containing a cosmetic liquid, the packaging connector comprising:
a tapered connector sized to receive a valve of a packaging containing a cosmetic liquid;
a preloaded spring (154) configured to press the tapered connector into said received packaging; and
a height adjustment mechanism (158) to accommodate different sizes of packaging;
a dispensing arm (130) configured to be fluidly connected to the packaging connector, the dispensing arm for dispensing a measured amount of the cosmetic liquid; and
a pump (140) configured to be fluidly connected to the packaging containing a cosmetic liquid.

10. System according to claim 9, wherein the connector is a universal connector.

11. System according to claim 9, wherein the valve of the cosmetic packaging comprises a spring-loaded valve.

12. System according to claim 9, therein the tapered connector comprises a conical, stepped conical, or tapered hollow shape.

13. System according to claim 9, the bottle connector (150) comprising an actuator configured to move the tapered connector against the valve.

14. System according to claim 13, wherein the actuator is an automated actuator.

15. System according to claim 13, wherein the actuator is a lever (152).

16. System according to claim 9, wherein the universal bottle connector (150) is configured to provide an leak-tight connection to the bottle.

17. System according to claim 9, further comprising a visual indicator for indicating when the bottle connector (150) is secured to the bottle.

18. System according to claim 9, wherein the universal bottle connector (150) is configured to attach to a bottle external to the system.

19. System according to claim 9, further comprising a housing (110) at least partially enclosing the system.

20. System according to claim 9, further comprising:
a motor (142) configured to run the pump (140); and
a motor axis sensor (144) configured to monitor position of the motor and the pump relative each other.

21. System according to claim 9, further comprising a dispensing tube (128) connecting the pump (140) to the bottle connector (150).

22. System according to claim 9, further comprising a proximity sensor (134) connected to the arm (130), the proximity sensor configured to detect an external surface near an opening (132) in the arm.

23. (canceled)

24. System according to claim 22, wherein the external surface is a sponge, pad, card, or strip.

25. System according to claim 9, further comprising a power source connected to the pump and the arm, wherein the power source is portable.

26. (canceled)
